(19) United States
(12) Patent Application Publication
(10) Pub. No.: US 2026/0098664 A1
(43) Pub. Date: Apr. 9, 2026

(54) Hypogeal Electricity Generator Using Sandy Al-Air Fuel Cells

(71) Applicant: Olurinde Ebenezer Lafe, Bentleyville, OH (US)

(72) Inventor: Olurinde Ebenezer Lafe, Bentleyville, OH (US)

(73) Assignee: Fuel Cells Global LTD, Bentleyville, OH (US)

(21) Appl. No.: 18/907,580

(22) Filed: Oct. 6, 2024

(51) Int. Cl. F24T 10/10; H01M 4/38; H01M 4/96; H01M 12/02; H01M 12/06

(52) U.S. Cl. CPC F24T 10/10; H01M 4/38; H01M 4/96; H01M 12/02; H01M 12/06

(57) ABSTRACT

A method and apparatus for generating electricity using ensemble electrochemical cells each comprising a tubular anodic inner chamber mesh, an anodic aluminum wire, a sandy anolyte medium, an anolyte based on a solution of sodium hydroxide or potassium hydroxide, a membrane separator, a carbonized cellulosic air-cathode doused in a catholyte, and an exterior mesh enclosure. The invention teaches the use of inexpensive materials and simple assembling of sandy fuel cells into a hypogeal electricity generator.

### REFERENCES

Bockstie, L., Trevethan, D. & Zaromb, S., 1963. Control of AI corrosion in caustic solutions. Journal of The Electrochemical Society, 110 (4), pp. 267-271.
Du Yuan, Jin Zhao, William Manalastas Jr., Sonal Kumar, Madhavi Srinivasan, 2020. Emerging rechageable aqueous aluminum ion battery: Status, challenges, and outlooks. Nano Materials Science, pp. 248-263.
Friesen, C. A. & Martinez, J. A. B., 2018. s.l. U.S. Pat. No. 10,090,520.
Friesen, C. A., McDowell, F. & Bautista, M. J. A., 2016. Aluminum-Based Metal-Air Batteries. United States of America, U.S. Pat. No. 9,236,643 B2.
Giuseppe, Antonio Elia, Kostiantyn V. Kravchyk, Maksym V. Kovalenko, Joaquin Chacon, Alex Holland, Richard G. A. Wills, 2021. An overview and prospective on AI and Al-ion battery technologies. Journal of Power Resources.
Miller, Y., Tzidon, D. & Yadgar, A., 2021. United States of America, US20210075078.
Mori, R., 2020. Recent Developments for Aluminum-Air Batteries. Electrochemical Energy Reviews, Volume 3, pp. 344-369.
Niksa, M. J., Niksa, A. J. & Noscal, J. M., 1990. Primary aluminum-air battery. United States of America, U.S. Pat. No. 492,5744.
Sasaki, K., 2015. United States of America, US20150009365. Wang, Y. et al., 2023. Solid-state Al-air battery with an ethanol gel electrolyte. Green Energy & Environment, 8 (4), pp. 1117-1127.
Zaromb, S., 1962. The use and behavior of aluminum anodes in alkaline primary batteries. Journal of The Electrochemical Society, 109 (12), pp. 1125-1130.

### FIELD OF INVENTION

The present invention generally relates to electricity generation, and more particularly to a method and apparatus for the conversion of the chemical energy stored in aluminum into electricity using metal-air electrochemical fuel cells.

### PRIOR ART

Fuel cells using metal-air have historically served as the building blocks for generators developed to meet practical applications. A metal-air fuel cell is fundamentally a primary battery. While the anode is a metal (e.g., aluminum, zinc, iron, magnesium, lithium, calcium, sodium, potassium, tin, and germanium), the cathode is oxygen drawn directly from ambient air. The result is a high energy density appliance because of the much-reduced weight of the cells.

Aluminum-air batteries were originally proposed by (Zaromb, 1962), and (Bockstie, et al., 1963). Developments in aluminum-air batteries were reviewed by (Mori, 2020) who provided background information on the advantages and disadvantages of several types of metal-air fuel cells and compared them with aluminum-air fuel cells. The strength of the high energy density of the aluminum-air fuel cell contrasts with the challenges in maintaining cathode stability and preventing performance-inhibiting water vapor ingress. While aqueous electrolytes provide excellent ionic conductivity and efficient aluminum dissolution, managing water loss and preventing dendrite formation have limited a broad adoption of aluminum-air fuel cells. (Wang, et al., 2023) tackled the issue of continuous aluminum corrosion during battery standby by using an ethanol gel electrolyte in an aluminum-air battery. Potassium hydroxide is the solute and polyethylene oxide the gelling agent.

Patents which taught different implementations of the aluminum-air fuel cell include:
(Niksa, et al., 1990) which describes an aqueous electrolyte aluminum-air battery with a consumable aluminum anode and an air cathode. The battery has a hydrophobic membrane that prevents the electrolyte from leaking out and allows hydrogen to escape. The battery is mechanically rechargeable by replacing the anode and/or the electrolyte.
(Miller, et al., 2021) which discloses aluminum-air battery units and stacks with frames that provide robust structural support and hermetic sealing for the anode and the cathode. The frame has a protective strap that protects the edges of the anode from corrosion and a trapezoidal shape that presses the strap against the anode. The anode can be replaced after electrolyte evacuation while maintaining the stack sealed.
(Friesen & Martinez, 2018) which relates to aluminum-based metal-air batteries that use an anode comprising an aluminum alloy and a cathode comprising a bifunctional catalyst. The batteries can have high energy density, high power density, and long cycle life. The batteries can also be recharged by electrochemical or mechanical methods.
(Sasaki, 2015) which proposes an aluminum-air battery and accumulator system that uses an electrolyte comprising a mixture of water and an ionic liquid. The system has a device for circulating the electrolyte between the battery and the accumulator, and a device for controlling the temperature and the pH of the electrolyte. The system can improve the performance and the lifetime of the battery.
(Friesen, et al., 2016) which describes an aluminum-air cell using an organic solvent electrolyte that forms a protective layer on the aluminum anode during non-use, enabling efficient oxidation during discharge.

### BACKGROUND OF THE INVENTION

An aluminum-air fuel-cell is an electrochemical apparatus with cathode consisting of oxygen extracted from the air, an alkaline electrolyte, and aluminum as the anode and the fuel. Aluminum-air fuel cells hold immense potential as a sustainable energy solution. Aluminum is a readily available and inexpensive resource, making an aluminum-air fuel cell a cost-effective energy solution. The major challenge facing the widespread adoption of aluminum-air electrochemistry for practical electricity generation is the anodic aluminum self-corrosion. The electricity production of the fuel cell is severely inhibited by the reaction of the aluminum with water/oxygen in the electrolyte resulting in the production of hydrogen gas. The electrochemical reactions in an aluminum-air fuel cell, with an alkaline electrolyte, is described by (Mori, 2020):

$$\begin{matrix}Anode : Al \to A {l}^{3 +} + 3 {e}^{-} \\ Cathode : {O}_{2} + 2 {H}_{2} O + 4 {e}^{-} \to 4 {OH}^{-} \\ Overall : 4 Al + 3 {O}_{2} + 6 {H}_{2} O \to 4 {Al ( OH )}_{3}\end{matrix}$$

Hydroxide ions are transported from the cathode to the anode through the medium of the electrolyte. The electricity production capacity, as well as the safety and stability of the fuel cell, is dependent on the nature of the electrolyte.

The typical aluminum-air fuel-cell normally converts a small fraction of the 8.1 kWh of chemical energy inherent in every kilogram of anodic aluminum into electricity. This invention teaches the use of dual electrolytes, and an anodic aluminum wire, to produce an energy efficient fuel cell. In the anodic chamber is an anolyte consisting of a sandy electrolyte derived from a compound solution of sodium hydroxide or potassium hydroxide (KOH) and fine sand. The cathodic chamber, which is separated from the anodic chamber by a low-cost membrane separator, uses vinegar as catholyte. The use of the sandy anolyte significantly reduces self-corrosion, limits parasitic gas production, and improves the performance of the aluminum-air fuel cell. Optimizing energy production per unit weight of anodic aluminum results in efficient ultra-low-cost electricity generators built using the aluminum-air fuel cell taught in this invention.

### SUMMARY OF THE INVENTION

According to the present invention there is provided a method of generating electricity form an electrochemical cell comprising a tubular anodic inner chamber mesh, an anodic aluminum wire, a sandy anolyte, a membrane separator, a carbonized cellulosic air-cathode doused in a catholyte, and an exterior mesh enclosure.

An advantage of the present invention is the provision of a method and apparatus for converting the intrinsic chemical energy of aluminum into electricity.

Another advantage of the present invention is the provision of a method and apparatus for electricity generation which provides maximal conversion of the chemical energy in aluminum into electricity.

Still another advantage of the present invention is the provision of a method and apparatus for electricity generation utilizing a sandy electrolyte which enhances the electrochemical reactions by suppressing anodic corrosion and the evolution of hydrogen.

Still another advantage of the present invention is the provision of a method and apparatus for electricity generation which utilizes an aluminum wire as the solid fuel.

Still another advantage of the present invention is the provision of a method and apparatus for electricity generation which utilizes a solid fuel completely consumed, at the end of the electrochemical process, without the necessity for complicated spent-fuel evacuation.

Still another advantage of the present invention is the provision of a method and apparatus for electricity generation which utilizes a low-cost cellulosic membrane separator.

Still another advantage of the present invention is the formation of the entirety of the tubular fuel cell by spiral wrapping the composite material consisting of layered fiberglass sheet, outer carbonized cellulosic material, conductive metal current collector, inner carbonized cellulosic material, membrane separator, and fiberglass.

Still another advantage of the present invention is the provision of a method and apparatus for electricity generation utilizing a sandy tubular fuel cells which are electrically connected and installed below the ground surface to form a hypogeal electricity generator.

Still other advantages of the invention will become apparent to those skilled in the art upon reading and understanding the following detailed description, accompanying drawings and appended claims.

### BRIEF DESCRIPTION OF DRAWINGS

The invention may take physical form in certain parts and arrangements of parts, a preferred embodiment and method of which will be described in detail in this specification and illustrated in the accompanying drawings which form a part hereof, and wherein:

FIG. 1 is an illustration of the isometric view of the Sandy Fuel Cell;

FIG. 2 is an illustration of the horizontal cross-section of the Sandy Fuel Cell;

FIG. 3 is an illustration of the vertical cross-section of the Sandy Fuel Cell;

FIG. 4 is an illustration of the isometric view of Sandy Fuel Cells arranged to form the Hypogeal Electricity Generator.

FIG. 5 is an illustration of the steps involved in the construction of the Sandy Fuel Cells.

FIG. 6 is an illustration of the steps involved in the construction of the Hypogeal Electricity Generator.

### DETAILED DESCRIPTION OF THE INVENTION

It should be appreciated that while a preferred embodiment of the present invention will be described with reference to aluminum-air fuel cell, other metal-air electrochemical cells are also suitable for use in connection with the present invention, such as zinc-air, iron-air, magnesium-air, lithium-air, calcium-air, sodium-air, potassium-air, tin-air, and germanium-air fuel cells.

In accordance with a preferred embodiment, the present invention teaches the generation of electricity using an electrochemical cell comprising: a) an inner chamber made of a mesh tube; b) an anode consisting of a thin aluminum wire; c) a sandy anolyte made from a compound solution of sodium hydroxide (NAOH) or potassium hydroxide (KOH), and fine sand; d) a vinegar-based catholyte; e) an air-cathode medium made from a carbonized porous cellulosic material; f) a membrane separator; and g) an exterior mesh enclosure.

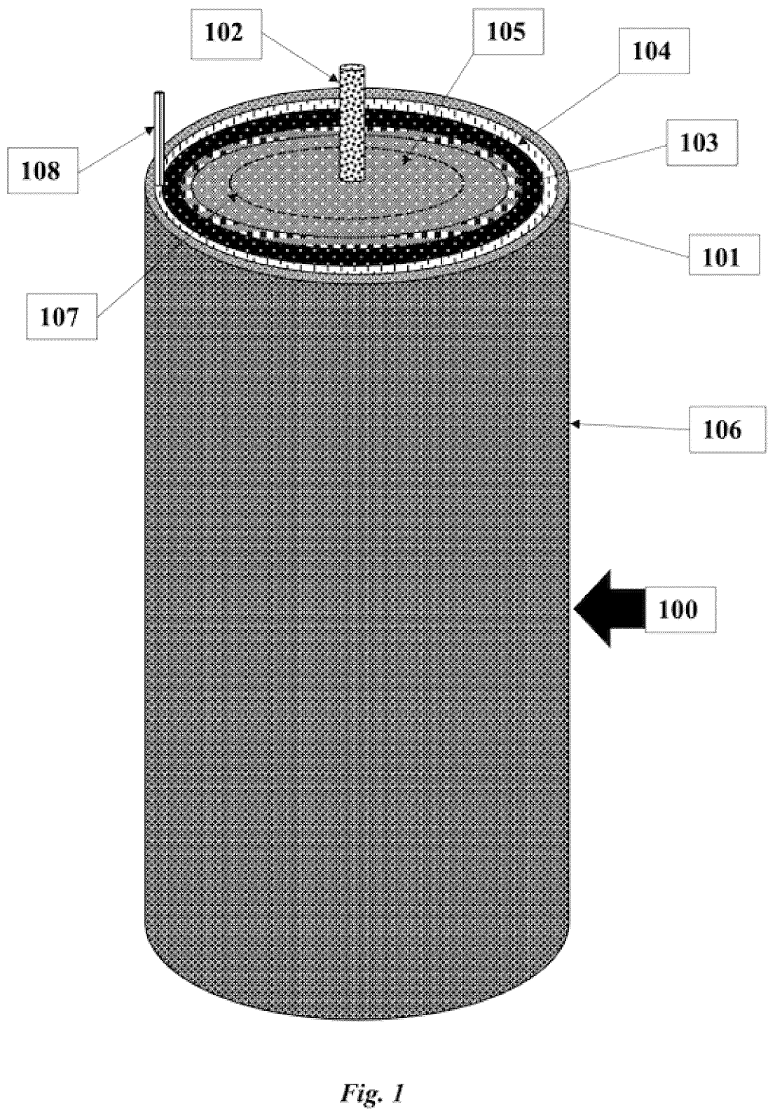

Referring now to the drawings wherein the showings are for the purposes of illustrating a preferred embodiment of the invention only and not for purposes of limiting same, FIG. 1 is an illustration of the isometric view of sandy fuel cell 100 with air cathode 101, anode 102, and exterior container 106.

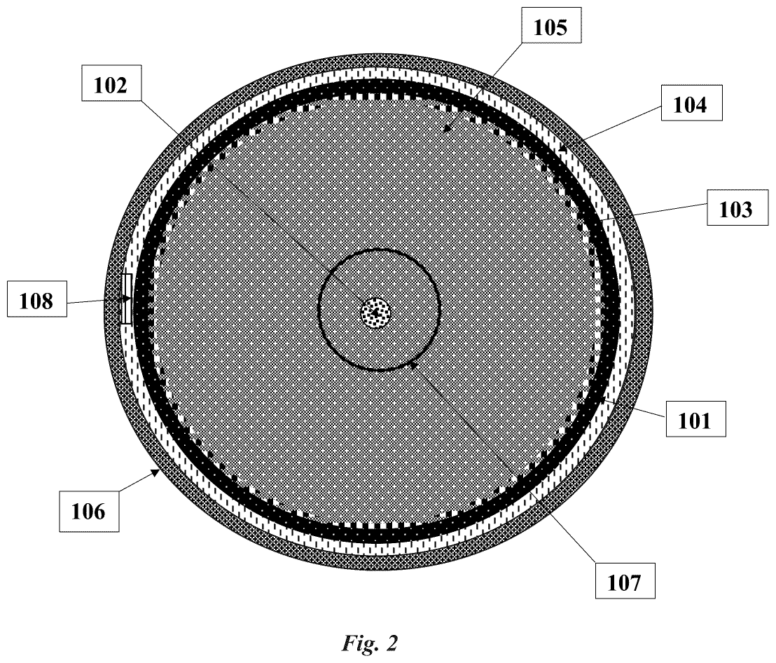

Referring now to FIG. 2:
1. Cathode 101. According to the preferred embodiment of this patent, cathode 102 consists of a folded carbonized absorbent cotton sheet.
2. Anode 102. According to the preferred embodiment of this patent, anode 102 is a single pure aluminum wire (Gauge: 9-18). The tip end of anodic aluminum wire 102 serves as the negative terminal for sandy fuel cell 100.
3. Membrane Separator 103: According to the preferred embodiment of this patent, membrane separator 103 consists of a common polyethylene material.
4. Current Collector 104: According to the preferred embodiment of this patent, current collector 104 consists of a composite material made of copper mesh sandwiched between perforated conductive copper foils.
5. Anolyte Medium 105. According to the preferred embodiment of this patent, Anolyte Medium 105 consists of fine sand.

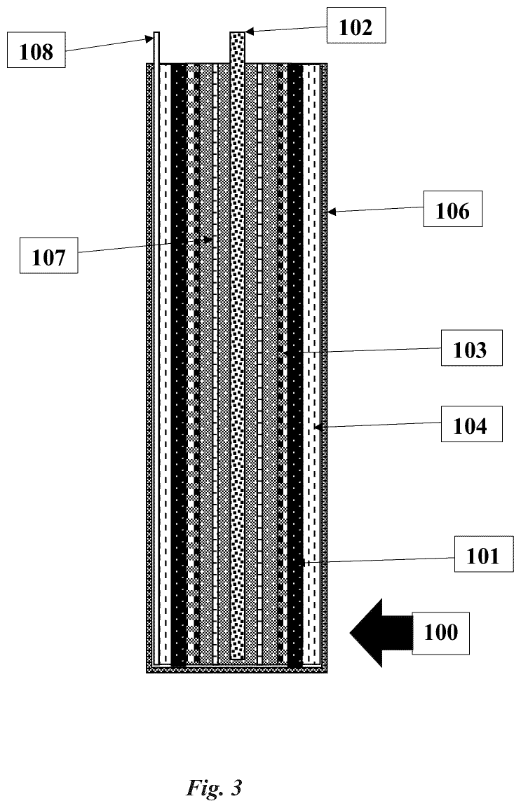

Referring now to FIG. 3:
1. Exterior Container 106. According to the preferred embodiment of this patent, exterior container 106 can consist of:
   a. a Rigid Plastic Mesh Tube (Thickness: 1.6 mm to 2.5 mm; Open Area: 37% to 48%)
   b. a Fiberglass Mesh Tube (Thickness: 0.3 mm; Mesh: 13)
2. Interior Mesh 107. According to the preferred embodiment of this patent, Interior Mesh 107 consists of a rigid plastic mesh tube (Thickness: 1.6 mm to 2.5 mm; Open Area: 37% to 48%) which prevents inadvertent physical contact between cathode 101 and anode 102.
3. Positive Terminal 108. According to the preferred embodiment of this patent, positive terminal 108 is a conductive metal connected to composite current collector 108. The preferred metal of choice is a nickel strip.

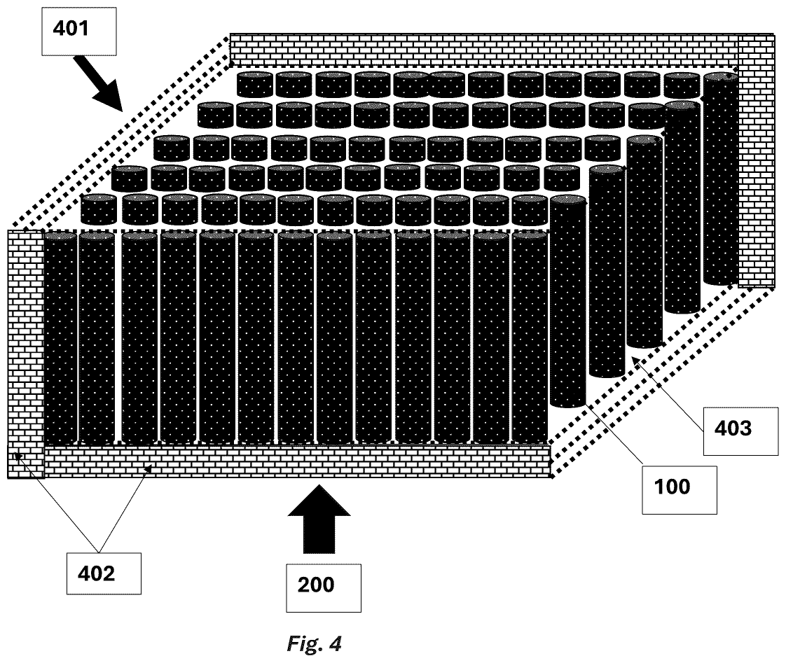

Referring now to FIG. 4:
1. Hypogeal Electricity Generator 200. According to the preferred embodiment of this patent, electricity generator 200 is built from a rectangular grid arrangement of fuel cells 100. Hypogeal Electricity Generator 200 is built inside rectangular ditch 401 stabilized with concrete blocks 402 and lined with vapor barrier 403.
2. Ditch 401. According to the preferred embodiment of this patent, ditch 102 consists of rectangular excavated cavity in the ground.
3. Concrete Blocks 402. According to the preferred embodiment of this patent, concrete blocks 402 consist of standard-size rectangular blocks used in building construction.
4. Vapor Barrier 403. According to the preferred embodiment of this patent, vapor barrier 403 consists of a plastic sheet capable of resisting the diffusion of moisture through the walls or floor of ditch 401.

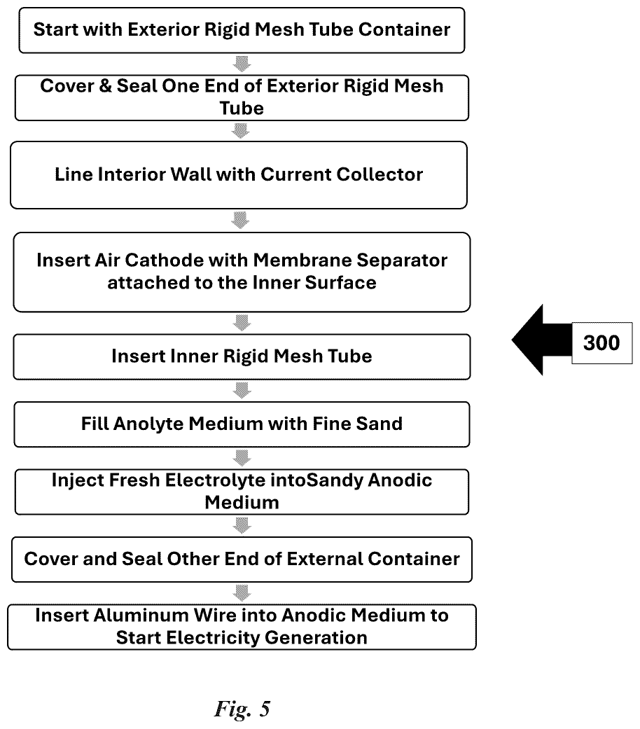

Referring now to FIG. 5, the steps 300 involved in the construction of the Fuel Cell 100 are:
Start with Exterior Rigid Mesh Tube Container 105
Cover & Seal One End of Exterior Rigid Mesh Tube 105.
Line Interior Wall with Current Collector 104.
Insert Air Cathode 101 with Membrane Separator 103 attached to the Inner Surface
Insert Inner Rigid Mesh Tube 107.
Fill Anolyte Medium 105 with fine sand
Inject Fresh Electrolyte into Sandy Anodic Medium 105.
Cover and Seal Other End of Rigid Mesh Tube External Container 106
Insert Aluminum Wire 102 into Anodic Medium to Start Electricity Generation

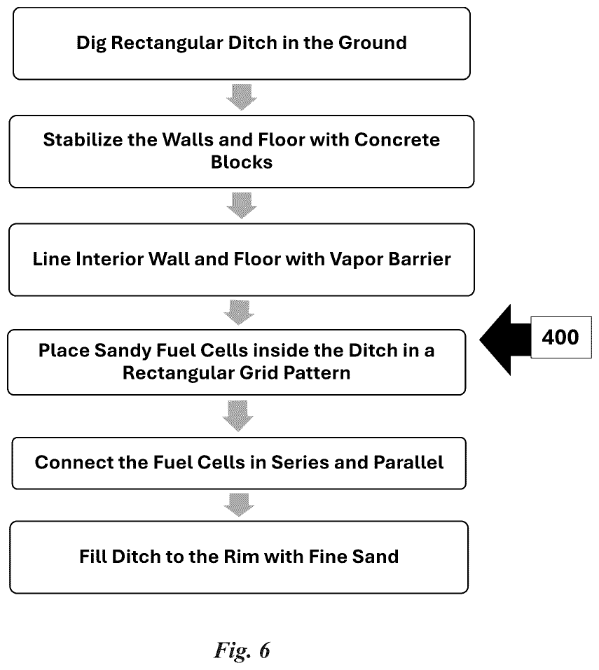

Referring now to FIG. 6, the steps 400 involved in the construction of Hypogeal Electricity Generator 200 are:
Dig Rectangular Ditch 401 in the Ground
Stabilize the Walls and Floor with Concrete Blocks
Line Interior Wall and Floor with Vapor Barrier 402.
Place Sandy Fuel Cells 100 inside Ditch 401 in Rectangular Grid Pattern
Connect the Fuel Cells 100 in Series and Parallel.
Fill Ditch 401 to the Rim with Fine Sand

### Example

To establish the characteristics of the fuel cell used in the construction of the hypogeal electricity generator, according to the invention disclosed herein, discharge tests were conducted on a cell of distinct size configurations and construction approaches. In the following example, the anolyte is from a mixture of 250 ml of sodium hydroxide, 250 ml of Manihot Esculenta (Cassava) starch, with 500 ml of H₂O. The catholyte is vinegar. The carbonized cellulosic material used for the air-cathode is a paper towel painted with carbon ink. The carbon ink is made from a mixture of activated carbon powder and manganese dioxide in a 2:1 (by weight) ratio.
Exterior Container: Rigid Mesh Plastic Tube (Diameter: 50 mm; Length: 420 mm; Open Area: 41%)
Anode: Aluminum wire (Diameter: 2 mm; Length: 500 mm; Gauge 12) Cylindrical coil (Diameter: 16 mm; Height: 420 mm) made by spirally winding 2 mm (Gauge 12) aluminum wire.
Anolyte: Solution of 300 grams of sodium hydroxide and 1000 ml of water
Anolyte Medium: Fine Sand.
Cathode: Carbonized absorbent cotton sheet (Width: 150 mm; Length: 420 mm). The carbon ink is a mixture of activated carbon powder and manganese dioxide in a 2:1 (by weight) ratio.
Catholyte: Vinegar (5% solution)
Dual Separators: Polyethylene sheet, and Rigid Mesh Plastic Tube (Diameter: 33 mm; Length: 420 mm; Open Area: 33%)
Discharge current: 100 mA
Discharge test duration: 22,094 minutes
Current Capacity: 36,823 mAh
Energy Produced: 24,423 mWh
Open Circuit Voltage: 1.5V
Average Operating Voltage: 0.7V

The present invention has been described with reference to a preferred embodiment. Obviously, modifications and alterations will occur to others upon a reading and understanding of this specification. It is intended that all such modifications and alterations be included insofar as they come within the scope of the appended claims or the equivalents thereof.

1. According to the present invention there is provided a method of generating electricity using buried ensemble dual-electrolyte electrochemical fuel cells each comprising an exterior container, an anode, a cathode, and an anolyte medium.

2. A method according to claim 1, wherein the anolyte is a compound solution of sodium hydroxide (NAOH) or potassium hydroxide (KOH), and a binder derived from Manihot Esculenta (known as Cassava).

3. A method according to claim 1, wherein the electrolyte medium consists of fine sand.

4. A method according to claim 1, wherein the air-cathode is a carbonized absorbent cellulosic material.

5. A method according to claim 1, wherein the membrane separator consists of a common polyethylene material.

6. A method according to claim 1, wherein the anode is aluminum wire.

7. A method according to claim 2, wherein the freshly made bioplastic anolyte, in fluid state, is injected into the anodic chamber.

8. A method according to claim 1, wherein an interior rigid mesh tube prevents inadvertent contact between the anode and the cathode.

9. A method according to claim 1, wherein sandy electrochemical fuel cells are connected in series and parallel and installed inside a rectangular ditch excavated in the ground to form a hypogeal electricity generator.

10. A method according to claim 9, wherein the rectangular ditch is pre-lined with rectangular concrete blocks and vapor barrier.
